(19) United States
(12) Patent Application Publication
(10) Pub. No.: US 2007/0220493 A1
(43) Pub. Date: Sep. 20, 2007

(54) Recording medium, software verification apparatus and software verification method

(75) Inventor: Rafael Kazumiti Morizawa, Kawasaki (JP)

Correspondence Address: Patrick G. Burns;GREER, BURNS & CRAIN, LTD., Suite 2500, 300 South Wacker Dr., Chicago, IL, 60606, US

(73) Assignee: FUJITSU LIMITED

(21) Appl. No.: 11/500,645

(22) Filed: Aug. 8, 2006

(30) Foreign Application Priority Data
Mar. 20, 2006 (JP) 2006-075898

(51) Int. Cl. G06F 9/44

(52) U.S. Cl. 717/126

(57) ABSTRACT

The present invention has been made to provide a software verification program, a software verification apparatus, and a software verification method capable of reducing verification cost of concurrent/parallel software.

A software verification program allowing a computer to execute verification of software including a library 11 and a program that uses a library 21 to operate in a concurrent or parallel manner, comprises: a shared element utilizing part extraction step that extracts a part at which a shared element, which is an element that is defined in the library 21 and which can be used by the program 22, is used in the program 22; and a condition verification step that verifies based on a thread-safe condition defined in the library 21 for the each shared element whether a shared element in the shared element utilizing part extracted by the shared element utilizing part extraction step satisfies the thread-safe condition.

### BACKGROUND OF THE INVENTION

1. Field of the Invention

The present invention relates to a recording medium that records in a computer-readable manner a software verification program, a software verification apparatus, and a software verification method that perform verification of concurrent/parallel software.

2. Description of the Related Art

In order to cope with an increase in the scale and complexity of computer software, a library which is a reusable software component having a fundamental function has come to be used by a software developer. Currently, the library is indispensable in the field of development of software (including from applications for embedded system to those for large-scaled system).

Software that runs in a concurrent/parallel manner on hardware is now required and, accordingly, software developers need to verify presence or absence of errors (data conflict, deadlock, etc.) specific to the concurrent/parallel software. In order to provide a library that can be embedded in the concurrent/parallel software, it is necessary to design a thread-safe library in consideration of concurrent/parallel operation (thread-safe design). The thread-safe library is a library in which data conflict and deadlock do not occur. For realization of the thread-safe design, a synchronization mechanism such as MUTEX lock is used in the library implementation.

However, a heavy use of the synchronization mechanism increases a part to be serially executed. This is not desirable in terms of performance. Therefore, library developers often reduce the level of a part of the synchronization mechanism for better performance.

As a prior art relating to the present invention, there is known a test method of concurrent/parallel program (refer to, for example, PCT Pat. Appin. Laid-Open Publication No. 8-502375).

However, a library in which the level of the synchronization mechanism has been reduced is not thread-safe. Therefore, in order to verify a concurrent/parallel program including such a library, it is necessary to verify not only a newly designed part but also the entire software including the library. In general, it takes a high cost (long time) to verify that concurrent/parallel software is thread-safe. In particular, in the case where a plurality of libraries are used to implement software, the verification cost becomes extremely high.

For verification of the concurrent/parallel software including a library, there exist the following verification techniques.

As a first verification technique, a test technique that is provided by a tool vendor and that uses a tool such as a debugger for detecting errors specific to the concurrent/parallel software is prevalent. This tool records all memory accesses that are made at the execution time of the software to detect data conflict from a pattern of accessing shared variables. Further, this tool detects an event in which a debugger stays in a given state and does not move therefrom to thereby sort out a deadlock state. However, creation of a test pattern for generating errors is difficult. Further, very long verification time is required to apply a sufficient test pattern, thus degrading verification efficiency.

As a second verification technique, a model check technique is available. With the model check technique, it is possible to cover a possibility of occurrence of data conflict or deadlock. Unlike the abovementioned test technique, a test pattern is not required in this technique. However, the model check technique is poor in scalability in relation to the size of software to be verified. Accordingly, processing time or required memory resource may extraordinarily increase depending on the scale of the software to be verified. Therefore, efficiency of formal verification of the large-scaled software and a library included in the software is very low.

### SUMMARY OF THE INVENTION

The present invention has been made to solve the above problems, and an object thereof is to provide a recording medium that records in a computer-readable manner a software verification program, a software verification apparatus, and a software verification method capable of reducing verification cost of concurrent/parallel software.

To solve the above problems, according to a first aspect of the present invention, there is provided a recording medium that records in a computer-readable manner a software verification program allowing a computer to execute verification of software including a library and a program that uses the library to operate in a concurrent or parallel manner. The software verification program allows a computer to execute: a shared element utilizing part extraction step that extracts a part at which a shared element, which is an element that is defined in the library and which can be used by the program, is used in the program; and a condition verification step that verifies based on a thread-safe condition defined in the library for the each shared element whether a shared element in the shared element utilizing part extracted by the shared element utilizing part extraction step satisfies the thread-safe condition.

In the recording medium according to the present invention, in the case where all shared elements in the shared element utilizing part in the program satisfy the thread-safe condition, the condition verification step performs thread-safe verification of a part other than the shared element utilizing part in the program.

In the recording medium according to the present invention, the thread-safe condition is written as an annotation corresponding to the shared element in the library.

In the recording medium according to the present invention, the shared element includes a shared variable and function provided by the library.

In the recording medium according to the present invention, the thread-safe condition is defined based on a result of the thread-safe verification performed for the shared element that has been determined not to be thread-safe by the thread-safe verification performed for the library.

In the recording medium according to the present invention, the thread-safe condition is defined based on the specification of the library.

In the recording medium according to the present invention, the shared element utilizing part extraction step separates the program into a section in which concurrent or parallel operation is performed and a section in which serial operation is performed based on the control flow analysis of the program and extracts the shared element utilizing part from the each section.

According to a second aspect of the present invention, there is provided a software verification apparatus that performs verification of software including a library and a program that uses the library to operate in a concurrent or parallel manner, comprising: a shared element utilizing part extraction section that extracts a part at which a shared element, which is an element that is defined in the library and which can be used by the program, is used in the program; and a condition verification section that verifies based on a thread-safe condition defined in the library for the each shared element whether a shared element in the shared element utilizing part extracted by the shared element utilizing part extraction section satisfies the thread-safe condition.

In the software verification apparatus according to the present invention, in the case where all shared elements in the shared element utilizing part in the program satisfy the thread-safe condition, the condition verification section performs thread-safe verification of a part other than the shared element utilizing part in the program.

In the software verification apparatus according to the present invention, the thread-safe condition is written as an annotation corresponding to the shared element in the library.

In the software verification apparatus according to the present invention, the shared element includes a shared variable and function provided by the library.

In the software verification apparatus according to the present invention, the thread-safe condition is defined based on a result of the thread-safe verification performed for the shared element that has been determined not to be thread-safe by the thread-safe verification performed for the library.

In the software verification apparatus according to the present invention, the thread-safe condition is defined based on the specification of the library.

In the software verification apparatus according to the present invention, the shared element utilizing part extraction section separates the program into a section in which concurrent or parallel operation is performed and a section in which serial operation is performed based on the control flow analysis of the program and extracts the shared element utilizing part from the each section.

According to a third aspect of the present invention, there is provided a software verification method that performs verification of software including a library and a program that uses the library to operate in a concurrent or parallel manner, comprising: a shared element utilizing part extraction step that extracts a part at which a shared element, which is an element that is defined in the library and which can be used by the program, is used in the program; and a condition verification step that verifies based on a thread-safe condition defined in the library for the each shared element whether a shared element in the shared element utilizing part extracted by the shared element utilizing part extraction step satisfies the thread-safe condition.

According to the present invention, it is possible to reduce verification cost of concurrent/parallel software.

### BRIEF DESCRIPTION OF THE DRAWINGS

FIG. 1 is a block diagram showing an example of a program verification apparatus according to the present embodiment;

FIG. 2 is a flowchart showing an example of operation of annotation addition processing according to the present embodiment;

FIG. 3 is a flowchart for showing an example of operation of the annotation addition processing according to the present invention;

FIG. 4 is a flowchart showing an example of operation of the program verification processing according to the present embodiment;

FIG. 5 is a flowchart showing an example of operation of the annotation verification processing according to the present invention;

FIG. 6 is source code of the library 11 in the first concrete example according to the present embodiment;

FIG. 7 is source code of the library 11 in the second concrete example according to the present embodiment;

FIG. 8 is source code of the library 11 in the third concrete example according to the present embodiment;

FIG. 9 is source code of the program 22 in the first concrete example according to the present embodiment;

FIG. 10 is source code of the program 22 in the second concrete example according to the present embodiment; and

FIG. 11 is source code of the program 22 in the third concrete example according to the present embodiment.

### DETAILED DESCRIPTION OF THE PREFERRED EMBODIMENTS

An embodiment of the present invention will be described below with reference to the accompanying drawings.

A configuration of a program verification apparatus according to the present embodiment will firstly be described.

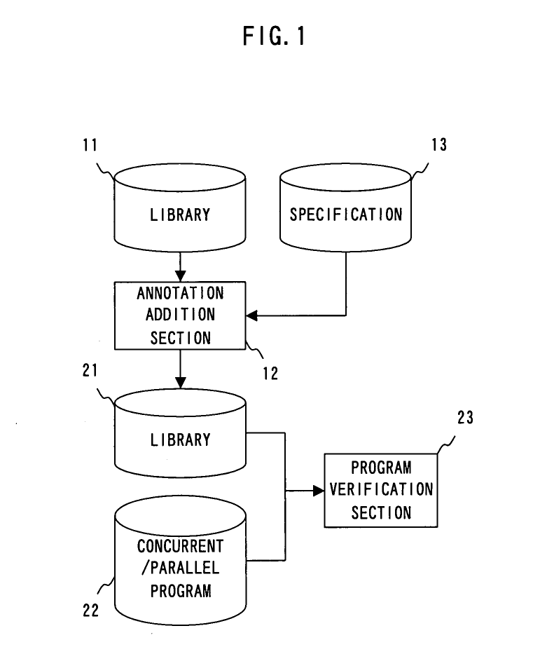

FIG. 1 is a block diagram showing an example of a program verification apparatus according to the present embodiment. The program verification apparatus shown in FIG. 1 includes a library 11, an annotation addition section 12, a specification 13, a library 21, a program 22 and a program verification section 23. The library 11 includes shared variables and functions (methods) which are resources that can be used from the program 22. The specification 13 is information related to the specification of the library 11. The program 22 is a concurrent/parallel program that uses the library 11 or library 12. An element in the library 21 that can be used from the program 22 is referred to as “shared element”.

A development flow of the concurrent/parallel program will next be described.

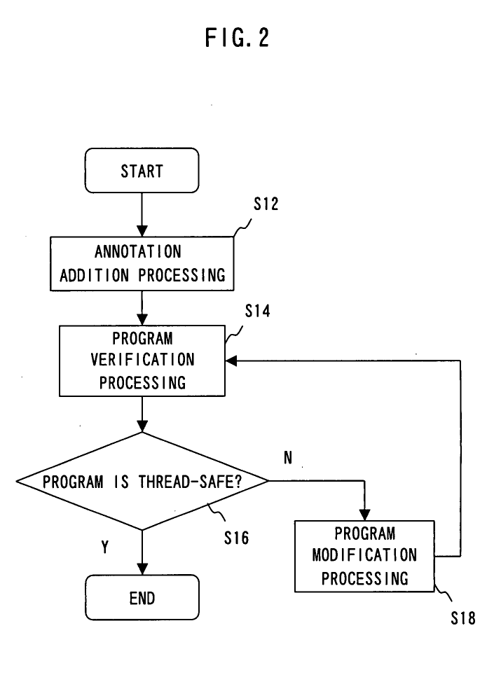

FIG. 2 is a flowchart showing an example of operation of annotation addition processing according to the present embodiment. The annotation addition section 12 performs annotation addition processing (annotation addition step) to add an annotation (verification information) to the library 11 which has been created by library developers to thereby generate the library 21 (S12). Then the program verification section 23 performs program verification processing for the program 22 and library 21 which have been created by program developers (S14) to determine whether the program 22 is thread-safe (S16). If the program 22 is determined not to be thread-safe (N in S16), it is modified by the program developers (S18). After that, the flow returns to step S14. On the other hand, if the program 22 is determined to be thread-safe (Y in Si 6), this flow is ended.

Details of the annotation addition processing will be described below.

It is assumed that objects in the library 11 to which an annotation is added by the annotation addition processing are “object variable” and “object function”. The object variable is a shared variable that can be seen from the program 22 in which the library 11 is embedded. The object function is a function that can be invoked from the program 22 in which the library 11 is embedded. The annotation is a necessary and sufficient condition for thread-safe operation when concurrent/parallel operation is performed for the object variable and object function.

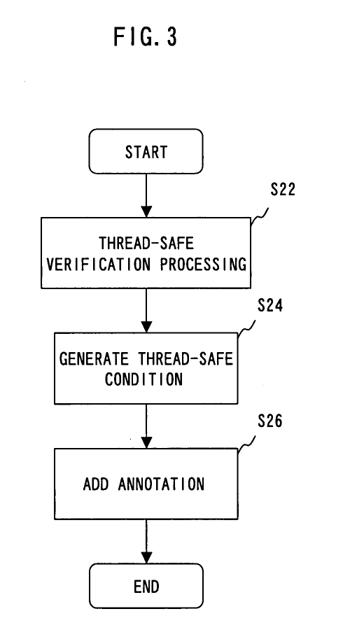

FIG. 3 is a flowchart for showing an example of operation of the annotation addition processing according to the present invention. The annotation addition section 12 performs thread-safe verification processing of the library 11 (S22). This thread-safe verification processing is performed for the abovementioned object variable and object function and uses a conventional rule-based checker, model check technique, simulation technique, or the like. As a result of the thread-safe verification, the position (line number) in the library 11 that is not thread-safe, reason, and condition are output. The annotation addition section 12 then converts the thread-safe verification result into a thread-safe condition which is a condition (constraint) defining thread-safe (S24). Subsequently, the annotation addition section 12 adds the thread-safe condition to the library 11 as an annotation and outputs its result as the library 21 (S26), and then this flow is ended.

If the thread-safe condition cannot automatically be derived only from the thread-safe verification result in step S24, information of the specification 13 is added to the thread-safe verification result followed by conversion into the thread-safe condition. Alternatively, the library developers create the thread-safe condition based on the thread-safe verification result and specification 13.

A case where a rule-based checker is used to perform the thread-safe verification processing of step S22 will be described below. An example of the contents of the rule is shown below.

Contents of Rule:

If variable Var is not a shared variable and its type is not final, the variable Var must hold a lock at the variable readout/write time, or a method in which readout/write is performed must hold a lock.

Whether variable Var is a shared variable or not is determined by isShared, and the type thereof can be determined by modifier. The readout of the variable is labeled as readAccess, and write of the variable is labeled as writeAccess. Whether variable Var has obtained a lock or not can be determined by holdsLock (Var). Whether method this has obtained a lock or not can be determined by holdsLock (this). Thus, a description of the rule including the above contents is represented as follows. If holdsLock method has a value of “true”, a lock has been obtained.

Description of Rule
if (isShared (Var) && modifier (Var)!=“final”) then readAccess (holdsLock (Var) or Thread. holdsLock (this));
if (isShared (Var) && modifier (Var)!=“final”) then writeAccess (holdsLock (Var) or Thread. holdsLock (this));

In generating the thread-safe condition (step S24), a description of the rule obtained from, e.g., the rule-based checker of step S22 is expanded by addition of a syntax representing concurrent/parallel operation or serial operation. An example of the expansion is shown below.
assert ifConcurrent (Thread. holdsLock (this));
assert ifSerial (flag==false);

In the case where ifconcurrent (conditional expression) is used, the conditional expression is evaluated only when a method including the assertion is operating in a concurrent/parallel manner. In the case where ifSerial (conditional expression) is used, the conditional expression is evaluated only when a method including the assertion is operating in a serial manner.

According to the above annotation addition processing, it is possible to reduce the cost of the thread-safe verification of the program 22 that uses the library 21 by including the condition under which the library 21 is thread-safe in the library 21 as an annotation. Further, by including the information of the specification in the thread-safe condition, it is possible to perform the thread-safe verification on adequate conditions as well as further reduce cost of the thread-safe verification of the program 22.

Details of the Program Verification Processing Will Next be Described.

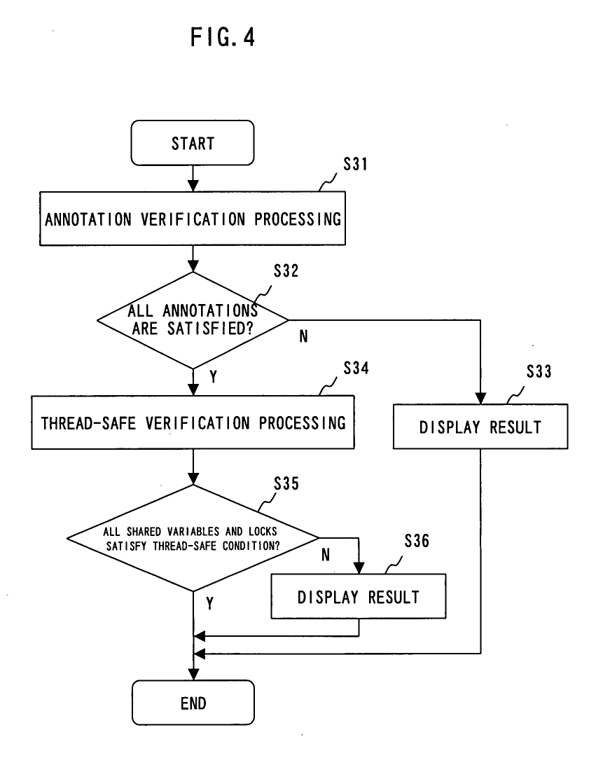

FIG. 4 is a flowchart showing an example of operation of the program verification processing according to the present embodiment. The program verification section 23 performs, on the source code of the program 22, annotation verification processing for the part (shared element utilizing part) that utilizes shared variables or methods in the library 21 to verify the annotation condition corresponding to that part (S31) and determines whether the program 22 satisfies the condition of all annotations (S32). If the program 22 does not satisfy the condition (N in S32), the program verification section 23 displays a verification result to indicate the corresponding position and content (S33), and this flow is ended. On the other hand, if the program 22 satisfies the annotation condition Y in S32), the program verification section 23 performs, on the source code of the program 22, thread-safe verification processing focused on shared variables and locks other than the shared variables and methods in the library 21 (S34) to determine whether all shared variables and locks satisfy the thread-safe condition (S35). The thread-safe verification processing in step S34 is performed using a conventional rule-based checker, model check technique, simulation technique, or the like, as in the case of the thread-safe verification processing in step S22.

If the tread-safe condition is not satisfied (N in S35), the program verification section 23 displays a verification result to indicate the corresponding position and content (S36), and this flow is ended. On the other hand, if the thread-safe condition is satisfied for all shared variables and locks (Y in S35), that is, if the program 22 is determined to be thread-safe, this flow is ended.

According to the program verification processing described above, it is possible to easily check whether the variables or functions in the program 22 that are associated with the library 21 are thread-safe based on the determination of the annotation condition. Further, by performing the same thread-safe verification as in the conventional art only for variables and functions that are not associated with the library 21, thread-safe verification cost can significantly be reduced.

Details of the Annotation Verification Processing of Step S31 Will Next be Described.

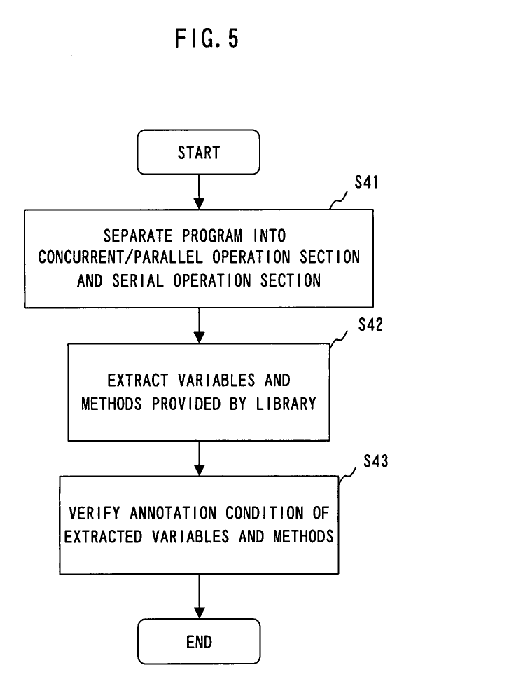

FIG. 5 is a flowchart showing an example of operation of the annotation verification processing according to the present invention. The program verification section 23 analyzes the control flow of the program 22 to separate the program 22 into two sections: concurrent/parallel operation section and serial operation section (S41). The program verification section 23 then extracts variables and methods provided by the library 21 from each section (S42). Subsequently, the program verification section 23 verifies annotation condition for the extracted variables and methods (S43). This flow is then ended and the program verification section 23 executes step S32.

In step S33, the program verification section 23 displays the position at which variables or methods that do not satisfy the annotation condition appear in the library 21 and program 22 and the content of corresponding annotation.

According to the annotation verification processing described above, the program 22 is separated into a concurrent/parallel operation section and serial operation section and variables and methods provided by the library 21 are extracted from each section, so that it is possible to make adequate determination on the annotation condition both at concurrent/parallel operation time and serial operation time.

According to the present embodiment, it is not necessary to perform thread-safe verification of the library 21 at the development time of the program 22, that is, it is only necessary to perform thread-safe verification of the program 22. Thus, verification time at the development time of the program 22 can be significantly reduced to increase the development efficiency of the program 22.

Next, the annotation addition processing will be described using a concrete example of the library 11 written in Java™.

The annotation addition processing in a first concrete example will be described.

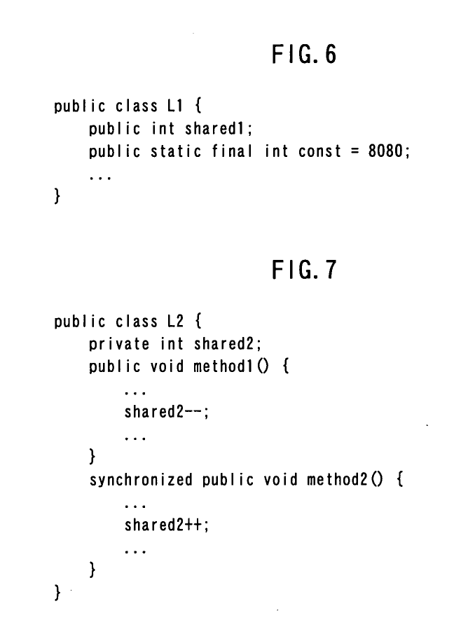

FIG. 6 is source code of the library 11 in the first concrete example according to the present embodiment. A class L1 is defined in the library 11. Variables shared1 and const in the L1 are both declared as public and, accordingly, they can be accessed (freely be referred to and used for assignment) from the program 22 that uses the L1.

When performing reference/assignment of shared 1, the program 22 which is a concurrent/parallel program must perform it through a synchronization mechanism (e.g., monitor). On the other hand, const is declared as final. In the Java language, once the value of a variable that is declared as final is defined, it is impossible to change the defined value, and all accesses are made to reference of value as in the case of a constant number. Therefore, a synchronization mechanism such as a lock is not required when the program 22 uses const.

Thus, annotations added by the annotation addition processing are as follows. shared1: must be protected by lock at reference/assignment time in program that uses L1. const: having no condition

Next, the annotation addition processing in a second concrete example will be described.

FIG. 7 is source code of the library 11 in the second concrete example according to the present embodiment. A class L2 is defined in the library 11. In the L2, variable shared2, method method1, method method2 are defined. Although shared2 is shared in the L2, it cannot be seen from the program 22 that uses the L2 since being declared as private. Therefore, an annotation need not be added to shared2.

On the other hand, method1 and method2 are declared as public and therefore they can be invoked by the program 22 that uses the L2. method1 and method2 refer to and assign variable shared2 that they share in the L2. It is necessary to lock methods at reference/assignment time of shared2 in order for methods to be thread-safe. Method2 is declared as synchronized. In the Java language, a method that is declared as synchronized accesses the shared variable (shared2) after acquiring a lock for the class (L2). On the other hand, since method1 is not declared as synchronized, there is a possibility that a data conflict involving variable shared2 occurs at concurrent/parallel operation time. This concrete example can be easily analyzed by using a conventional static analysis such as rule-based check or model check technique in step S22.

Thus, annotations added by the annotation addition processing are as follows.
shared2: having no condition
method1: must to be invoked after acquisition of lock of 12
method2: having no condition

Next, the annotation addition processing in a third concrete example will be described.

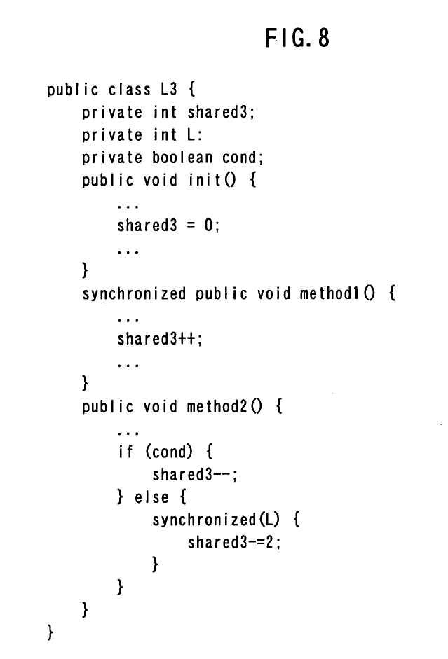

FIG. 8 is source code of the library 11 in the third concrete example according to the present embodiment. A class L3 is defined in the library 11. L3 provides three variables (shared3, L, cond) and three methods (init, method1, method2). Their specifications are as follows.
init is executed only one time in initialization. Concurrent/parallel operation is not supposed to be performed in the initialization time.
the value of cond is always false in the concurrent/parallel operation. When the value of cond is true, serial operation is guaranteed.

shared3 is declared as private and therefore it cannot be seen from the program 22 that uses the L3, so that an annotation need not be added to shared3. L and cond are declared as private, so that an annotation need not be added to L and cond, as in the case of shared3. inft, method1, and method2 refer to and assign a variable that they share in the L3, respectively. When thread-safe verification is mechanically performed (e.g., rule-based check, model check technique), only method method1 is determined to be thread-safe; and methods init and method2 are determined not to be thread-safe.

Therefore, when an annotation is mechanically added to methods init and method2 only by using the thread-safe verification result, annotations are as follows.
init: must be invoked after acquisition of lock of L3
method1: having no condition
method2: when cond is true, must be invoked after acquisition of lock of L3

Since the above specification of L3 shows that init is executed only one time under non-concurrent/parallel operation time, this specification is added to the annotation as a condition at the method invocation time. Further, when cond is true in method2, shared3 is referred to and assigned without the use of a synchronization mechanism (in this case, synchronized block). However, when cond is true, serial operation is guaranteed according to the specification of the L3. It is possible to easily derive that method method2 is thread-safe from the information of the specification.

Thus, adequate annotations obtained by using the specification of the L3 in addition to the thread-safe verification are as follows.
init: concurrent/parallel operation is not performed in method invocation time; and
number of invocations is only one
methods: having no condition
method2: having no condition

When there is a need to consider the information from the specification of the class as shown in the above example, it is impossible to add an adequate annotation only by using a condition mechanically derived from the conventional thread-safe verification result. In such a case, the annotation addition section 12 adds the information of the specification to the annotation. Alternatively, library developers add the information based on the specification.

Details of the program verification processing will be described using a concrete example of the program 22 corresponding to the abovementioned concrete examples of the library 11.

Firstly, the program verification processing in the above first concrete example will be described.

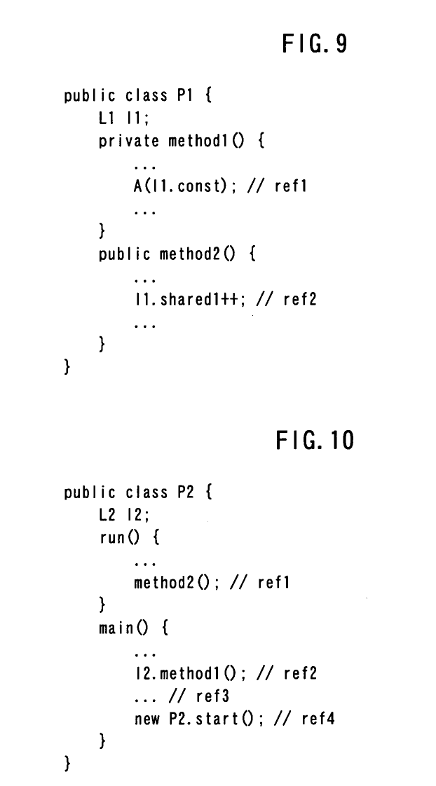

FIG. 9 is source code of the program 22 in the first concrete example according to the present embodiment. A class P1 is defined in the program 22. The P1 uses the library 21 (class L1) generated by the first concrete example. The specification of the P1 is as follows.

### Methods method1 and method2 Operate in a Concurrent Manner

When focusing attention on a variable and method that the L1 in the P1 provides, const is referred to in method1 (ref1), and shared1 is referred to in method2 (ref2).

Since the annotation of const is “having no condition”, the condition for the P1 of the program 22 to operate in a thread-safe manner is satisfied. On the other hand, the annotation of shared1 shows that a lock needs to be acquired at access time in order for the P1 to operate in a thread-safe manner. It is possible to easily determine that this condition is not satisfied by a simulation using an assertion.

The assertion description that checks the acquisition of a lock is as follows. assert Thread. holdsLock (this);

The assertion description indicates that a method (in this case, represented as “this”) including the assertion description must acquire a lock.

Accordingly, the program verification section 23 determines based on the program verification processing that the program 22 is not thread-safe and displays information related to the position (ref2) at which the program 22 accesses shared1 and annotation information of shared1 to prompt the program developers to correct the program 22.

The program verification processing in the above second concrete example will next be described.

FIG. 10 is source code of the program 22 in the second concrete example according to the present embodiment. A class P2 is defined in the program 22. The P2 uses the library 21 (class L2) generated by the second concrete example. When focusing attention on methods that the L2 in the P2 provides, method2 is invoked in run method (ref1), and method1 is invoked in main method (ref2).

In the Java language, the run method is a special method and one thread is started when the start method is invoked. That is, when the run method is invoked, concurrent/parallel thread is started. Since the annotation of method2 is “having no condition”, the condition for method2 to operate in a thread-safe manner in the program P2 is satisfied.

On the other hand, method1 is invoked in main method in a state where the class L2 is not locked. As a result of the analysis of the control flow of the P2 in step S41, the P2 operates in a serial manner from the start of main method to ref3 and starts concurrent operation from the invocation (ref4) of start method. Since method1 is invoked in the serial operation section, the annotation condition which is a condition for concurrent/parallel operation is not pertinent. Therefore, even when the P2 invokes method1 without acquisition of a lock of the L2, a data conflict or deadlock does not occur.

Therefore, based on the program verification processing, the program verification section 23 determines that the program 22 is thread-safe.

The program verification processing in the above third concrete example will next be described.

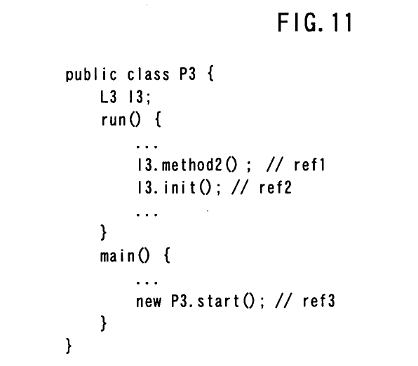

FIG. 11 is source code of the program 22 in the third concrete example according to the present embodiment. A class P3 is defined in the program 22. The P3 uses the library 21 (class L3) generated by the third concrete example. When focusing attention on methods that the L3 in the P3 provides, method2 is invoked in run method (ref1), and init is invoked in main method.

Since method1 provided by the L3 is not referred to in the P3, it is not necessary to verify whether the annotation condition is satisfied. The annotation condition of init provided by the L3 prohibits invocation from the concurrent/parallel operation section. As is easily seen from the result of the control flow of the P3 in step S41, sequential operation is performed from the start of main method to immediately before ref3 and concurrent/parallel operation is performed after ref3. Further, it can easily be seen that init is invoked from the concurrent/parallel operation section. Therefore, init does not satisfy the annotation condition.

On the other hand, since the annotation of method2 is “having no condition”, the condition for method2 to operate in a thread-safe manner in the P3 is satisfied.

Accordingly, the program verification section 23 determines based on the program verification processing that the program 22 is not thread-safe and displays information related to the position (ref2) at which the program 22 accesses shared1 and annotation information of init to prompt the program developers to correct the program 22.

The software verification apparatus according to the present embodiment can easily be applied to an information processing apparatus to thereby increase the performance thereof. Examples of the information processing apparatus include a PC (Personal Computer), a server, a workstation, and the like.

Further, it is possible to provide a program that allows a computer constituting the software verification apparatus to execute the above steps as a software verification program. By storing the above program in a computer-readable storage medium, it is possible to allow the computer constituting the software verification apparatus to execute the program. The computer-readable recording medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

A shared element utilizing part extraction step corresponds to steps S41 and S42 mentioned in the embodiment. A condition verification step corresponds to step S43 mentioned in the embodiment. A shared element utilizing part extraction section and a condition verification section correspond to the program verification section 23.

What is claimed is:

1. A recording medium that records in a computer-readable manner a software verification program allowing a computer to execute verification of software including a library and a program that uses the library to operate in a concurrent or parallel manner,
the software verification program allows a computer to execute:
a shared element utilizing part extraction step that extracts a part at which a shared element, which is an element that is defined in the library and which can be used by the program, is used in the program; and
a condition verification step that verifies based on a thread-safe condition defined in the library for the each shared element whether a shared element in the shared element utilizing part extracted by the shared element utilizing part extraction step satisfies the thread-safe condition.

2. The recording medium according to claim 1, wherein
in the case where all shared elements in the shared element utilizing part in the program satisfy the thread-safe condition, the condition verification step performs thread-safe verification of a part other than the shared element utilizing part in the program.

3. The recording medium according to claim 1, wherein
the thread-safe condition is written as an annotation corresponding to the shared element in the library.

4. The recording medium according to claim 1, wherein
the shared element includes a shared variable and function provided by the library.

5. The recording medium according to claim 1, wherein
the thread-safe condition is defined based on a result of the thread-safe verification performed for the shared element that has been determined not to be thread-safe by the thread-safe verification performed for the library.

6. The recording medium according to claim 5, wherein
the thread-safe condition is defined based on the specification of the library.

7. The recording medium according to claim 1, wherein
the shared element utilizing part extraction step separates the program into a section in which concurrent or parallel operation is performed and a section in which serial operation is performed based on the control flow analysis of the program and extracts the shared element utilizing part from the each section.

8. A software verification apparatus that performs verification of software including a library and a program that uses the library to operate in a concurrent or parallel manner, comprising:
a shared element utilizing part extraction section that extracts a part at which a shared element, which is an element that is defined in the library and which can be used by the program, is used in the program; and
a condition verification section that verifies based on a thread-safe condition defined in the library for the each shared element whether a shared element in the shared element utilizing part extracted by the shared element utilizing part extraction section satisfies the thread-safe condition.

9. The software verification apparatus according to claim 8, wherein
in the case where all shared elements in the shared element utilizing part in the program satisfy the thread-safe condition, the condition verification section performs thread-safe verification of a part other than the shared element utilizing part in the program.

10. The software verification apparatus according to claim 8, wherein
the thread-safe condition is written as an annotation corresponding to the shared element in the library.

11. The software verification apparatus according to claim 8, wherein
the shared element includes a shared variable and function provided by the library.

12. The software verification apparatus according to claim 8, wherein
the thread-safe condition is defined based on a result of the thread-safe verification performed for the shared element that has been determined not to be thread-safe by the thread-safe verification performed for the library.

13. The software verification apparatus according to claim 12, wherein
the thread-safe condition is defined based on the specification of the library.

14. The software verification apparatus according to claim 8, wherein
the shared element utilizing part extraction section separates the program into a section in which concurrent or parallel operation is performed and a section in which serial operation is performed based on the control flow analysis of the program and extracts the shared element utilizing part from the each section.

15. A software verification method that performs verification of software including a library and a program that uses the library to operate in a concurrent or parallel manner, comprising:
a shared element utilizing part extraction step that extracts a part at which a shared element, which is an element that is defined in the library and which can be used by the program, is used in the program; and
a condition verification step that verifies based on a thread-safe condition defined in the library for the each shared element whether a shared element in the shared element utilizing part extracted by the shared element utilizing part extraction step satisfies the thread-safe condition.

16. The software verification method according to claim 15, wherein
in the case where all shared elements in the shared element utilizing part in the program satisfy the thread-safe condition, the condition verification step performs thread-safe verification of a part other than the shared element utilizing part in the program.

17. The software verification method according to claim 15, wherein
the thread-safe condition is written as an annotation corresponding to the shared element in the library.

18. The software verification method according to claim 15, wherein
the shared element includes a shared variable and function provided by the library.

19. The software verification method according to claim 15, wherein
the thread-safe condition is defined based on a result of the thread-safe verification performed for the shared element that has been determined not to be thread-safe by the thread-safe verification performed for the library.

20. The software verification method according to claim 19, wherein
the thread-safe condition is defined based on the specification of the library.
